(19) United States
(12) Patent Application Publication
(10) Pub. No.: US 2022/0127695 A1
(43) Pub. Date: Apr. 28, 2022

(54) PROCESSING ORES CONTAINING PRECIOUS METALS

(71) Applicant: NEWCREST MINING LIMITED, Melbourne (AU)

(72) Inventor: John O'Callaghan, Melbourne (AU)

(73) Assignee: NEWCREST MINING LIMITED, Melbourne (AU)

(21) Appl. No.: 17/428,397

(22) PCT Filed: Feb. 5, 2020
(86) PCT No.: PCT/AU2020/050086

§ 371 Date: Aug. 4, 2021

(30) Foreign Application Priority Data
Feb. 5, 2019 (AU) 2019900350

(51) Int. Cl. C22B 1/11; C22B 1/24; B03D 1/12; B03D 1/14

(52) U.S. Cl. CPC C22B 1/11; C22B 1/24; B03D 2203/025; B03D 1/14; B03D 1/12

(57) ABSTRACT

A method of recovering gold from gold-containing sulphide minerals in an ore that has a recovery-oxidation curve in a graph of % recovery of gold versus % oxidation of the minerals that has a slope of less than 1:1 in a higher % oxidation part of the curve, includes operating at least one oxidation unit to achieve a target % oxidation for sulphur in the ore that is in a higher oxidation part of the curve and producing an output having liberated gold as a consequence of sulphur oxidation in the oxidation unit and allowing variations of the % oxidation in the oxidation unit during the method.

### TECHNICAL FIELD

The invention relates to recovering precious metals, such as gold and silver, from minerals in ores.

The invention relates particularly, although by no means exclusively, to recovering gold from gold-containing sulphide minerals, typically pyrite or arsenian pyrite, in ores.

The following description of the invention focuses on recovering gold from gold-containing sulphide minerals, typically pyrite or arsenian pyrite, in ores. However, it is emphasized that the invention extends generally to recovering precious metals from ores.

### BACKGROUND ART

One known method for recovering gold from gold-containing sulphide minerals, such as gold-bearing pyrite and arsenian pyrite minerals, in ores includes:

(a) oxidizing sulphur in milled ore and/or flotation concentrates of milled ore under pressure oxidation conditions in an oxidation unit, such as an autoclave, and

(b) recovering gold from an output of the oxidation step.

The applicant has developed an improvement to the known method.

The above description is not an admission of the common general knowledge in Australia or elsewhere.

### SUMMARY OF THE DISCLOSURE

The invention is relevant to greenfield plants and brownfield plants.

The invention relates to recovering gold from gold-containing sulphide minerals, such as gold-bearing pyrite and arsenian pyrite minerals, in ores that have recovery-oxidation curves in a graph of % recovery of gold versus % oxidation of sulphur in the minerals that have slopes of less than 1:1 in higher oxidation parts of the curves, where the term “higher % oxidation part of the curve” is typically understood herein to mean at least 50% oxidation.

FIG. 1 is an example of a graph of % recovery of gold versus % oxidation of sulphur in the minerals in a number of gold-containing ores. The Figure is discussed in more detail below.

The invention is based on a realization that the recovery-oxidation curves for the ores described above (referred to herein as “these ores”) provides an opportunity to design and operate a greenfield plant and to operate a brownfield plant at a target % oxidation value for sulphur that allows unit operations in the plant to be optimized and therefore provides an opportunity to achieve savings in capital and operating costs.

More particularly, the invention is not limited to operating oxidation units at close to 100% oxidation of available sulphur. This means that the invention provides considerable flexibility in terms of optimizing gold recovery when there are changes in plant operating conditions, such as oxidation unit capacity.

The invention is also based on a realization that oxidation of sulphur in these ores in greenfield and brownfield plants can be allowed to vary from a target % oxidation value in the higher % oxidation part of the curve without significantly affecting the oxidation units, such as autoclave units. In this context, the invention is not confined to the conventional practice of operating to achieve complete oxidation in oxidation units.

Variable oxidation of sulphur in these ores makes it possible to increase mass throughput for oxidation units, such as autoclave units, with higher sulphur concentrations in the output of the oxidation units (while still burning the same amount of sulphur at maximum operation of autoclave units) and potentially increased gold production at lower recoveries.

Variable oxidation of sulphur in these ores is relevant to normal plant operation and to operation under reduced capacity conditions, i.e. in situations in which there is a loss of equipment uptime for example when equipment is off-line or has reduced capacity.

Variable oxidation of sulphur in these ores also provides an opportunity for significantly increased gold production in brownfield plants.

Variable oxidation of sulphur in these ores also allows changes in % oxidation having regard to variations in feed mineralogy, etc. without significantly affecting the recovery of the plant.

For example, allowing variable % oxidation of sulphur in these ores means that oxidation units can be operated with fixed parameters, such as constant oxygen addition, without significantly affecting the recovery of the plant.

With the recovery-oxidation curves for these ores, changes in oxidation in the higher % oxidation parts of the curves do not have a significant effect on recovery. Therefore, a plant can be designed to operate effectively at a target % oxidation value below complete oxidation of sulphur and within the higher % oxidation parts of the curves.

One advantage of such a plant for these ores is that changes in ore preparation unit capacity (such as mill unit capacity) and/or oxidation unit (such as autoclave unit) capacity do not having a significant effect on recovery and therefore allow the plant to continue to operate within the same target range of % oxidation values of sulphur in the event that there is a change in ore preparation unit capacity and oxidation unit capacity.

Another advantage of such a plant is that selecting a target % oxidation value for these ores below complete oxidation of sulphur has advantages in terms of capital and operating costs in a greenfield plant and in operating costs in a brownfield plant.

Specifically, in the case of a greenfield plant, a plant owner can design operating units to be optimal for a selected target range of % oxidation values for these ores, with savings in capital costs compared to capital costs for the conventional complete % oxidation of sulphur option. The unit operating costs should also be lower compared to unit operating costs for the complete oxidation option.

The invention is not limited to a particular oxidation technology.

Different oxidation technologies, such as but not limited to autoclaves, atmospheric tanks, bio-oxidation systems, heap leach systems, and nitric acid systems, are all possible and follow the same fundamental rules.

The invention extends to greenfield plants with and without a sulphide concentration unit, such as a flotation unit.

A sulphide concentration unit, such as a flotation unit, is however necessary when preparation unit (such as mill units) capacity is greater than oxidation unit capacity and the ore preparation unit continues to operate at capacity. In this situation, the flotation unit can take up excess ore preparation unit capacity and balance preparation unit capacity and oxidation unit capacity.

Further to the preceding paragraph, there is a preference for operating (a) ore preparation unit, such as mills, at maximum production rate and (b) oxidation units at maximum production. In this embodiment of the invention, the flotation or other concentration units provide an opportunity to take up excess ore preparation unit output in the event of oxidation unit breakdown or reduction in oxidation unit capacity.

With the above in mind, in broad terms, the invention provides a method of recovering gold from gold-containing sulphide minerals in an ore that has a recovery-oxidation curve in a graph of % recovery of gold versus % oxidation of the minerals that has a slope of less than 1:1 in a higher % oxidation part of the curve, includes operating at least one oxidation unit to achieve a target % oxidation for sulphur in the ore that is in a higher oxidation part of the curve and producing an output having liberated gold as a consequence of sulphur oxidation in the oxidation unit and allowing variations of the % oxidation in the oxidation unit during the method.

Typically, the invention also provides a method of recovering gold from gold-containing sulphide minerals, such as gold-bearing pyrite and arsenian pyrite minerals, in an ore that has a recovery-oxidation curve in a graph of % recovery of gold versus % oxidation of the minerals that has a slope of less than 1:1 in a higher % oxidation part of the curve, including:

(a) processing a mined ore in an ore preparation unit that includes, for example, comminution and size separation units, such as crushing and milling units, and producing an ore preparation unit output,

(b) selecting the operating conditions for a plurality of oxidation units, such as autoclave units, to achieve a target % oxidation or a target range of % oxidation values for sulphur in the preparation unit output in at least one oxidation unit, such as an autoclave unit, that is in a higher oxidation part of the curve and less than complete oxidation; and

(c) operating the oxidation unit or units in accordance with the operating conditions and oxidizing sulphur in the ore preparation unit output and producing an output having liberated gold as a consequence of sulphur oxidation in the oxidation unit or units; and

(d) allowing variations of the % oxidation in oxidation units, such as autoclave units during the method.

Typically, the invention also provides a method of recovering gold from gold-containing sulphide minerals, such as gold-bearing pyrite and arsenian pyrite minerals, in an ore that has a recovery-oxidation curve in a graph of % recovery of gold versus % oxidation of the minerals that has a slope of less than 1:1 in a higher % oxidation part of the curve, including:

(a) processing a mined ore in an ore preparation unit that includes, for example, comminution and size separation units, such as crushing and milling units, and producing an ore preparation unit output,

(b) selecting a target % oxidation for sulphur in the ore of the ore preparation unit output to be in a higher oxidation part of the curve and less than complete oxidation; and

(c) selecting the operating conditions for a plurality of oxidation units, such as autoclave units, to achieve the target % oxidation for sulphur in the preparation unit output in at least one oxidation unit, such as an autoclave unit, and operating the oxidation unit or units in accordance with the operating conditions and oxidizing sulphur in the ore preparation unit output and producing an output having liberated gold as a consequence of sulphur oxidation in the oxidation unit or units; and

(d) allowing variations of the % oxidation in oxidation units, such as autoclave units during the method.

Typically, the invention also provides a method of recovering gold from gold-containing sulphide minerals, such as gold-bearing pyrite and arsenian pyrite minerals, in an ore that has a recovery-oxidation curve in a graph of % recovery of gold versus % oxidation of the minerals that has a slope of less than 1:1 in a higher % oxidation part of the curve, including:

(a) processing a mined ore in an ore preparation unit that includes, for example, comminution and size separation units, such as crushing and milling units, and producing an ore preparation unit output,

(b) selecting a target range of % oxidation values for sulphur in the ore of the ore preparation unit output to be in a higher oxidation part of the curve and less than complete oxidation; and

(c) selecting the operating conditions for a plurality of oxidation units, such as autoclave units, to achieve oxidation in the target range of % oxidation values for sulphur in the preparation unit output in at least one oxidation unit, such as an autoclave unit, and operating the oxidation unit or units in accordance with the operating conditions and oxidizing sulphur in the ore preparation unit output and producing an output having liberated gold as a consequence of sulphur oxidation in the oxidation unit or units; and

(d) allowing variations of the % oxidation in the oxidation units, such as autoclave units, during the method.

The method is an alternative to the conventional operating practice of complete oxidation.

An important advantage of the method is that the oxidation units are not the key unit operation in terms of controlling the operation on the plant and there is greater flexibility to optimize and accommodate variations in the upstream and downstream unit operations of the plant. More particularly, the method makes it possible for corrections to operating parameters to occur automatically to compensate for loss of equipment uptime without impacting significantly on gold production and, in some situations, making it possible to increase gold production. Factors that are relevant to this feature include the selection of ores that have a slope of less than 1:1 in the higher % oxidation part of the curve and step (d) of allowing variations of the % oxidation in oxidation units, such as autoclave units, during the method.

The gold-containing sulphide minerals may be any suitable minerals.

For example, the sulphide minerals may be pyrite or arsenian pyrite.

Processing step (a) may include operating the ore preparation unit at maximum capacity of the system. From an operational perspective, this may be a preferred option to an option of changing the operation of the ore preparation unit.

With regard to oxidation step (c), it is noted that sulphide oxidation occurs when the oxidation state of sulphur within a sulphide mineral, such as pyrite, is increased. Typically, sulphur in the sulphide state is at the −2-oxidation state. Oxidation can occur typically to the 0-oxidation state, i.e. to elemental sulphur, or to the +6-oxidation state as typically is the case for sulphate SO₄²⁻.

In the context of the invention, oxidation is understood to occur when there is an increase in the oxidation state.

Step (d) may include allowing variations of the % oxidation in response to ore type, sulphur grade, and equipment uptime.

The target % oxidation range may be any suitable % oxidation range in the part of the recovery-oxidation curve for the ore that has the slope of less than 1:1.

The lower limit of the target % oxidation range may be the lowest oxidation value that that has the slope of less than 1:1.

For example, the lower limit may be the target % oxidation value at which the slope of the recovery vs oxidation curve changes from <1:1 to >1:1 in the curves 5 shown in FIG. 1, whilst noting that the shape of the curves may be different for different ores and different ore blends. By way of particular example, the curves may be straight lines or curved lines.

Taking the curves 5 shown in FIG. 1 as a specific example, the target % oxidation range may be between a lower oxidation value of 50% and a higher oxidation value of 100%. It is noted that in other situations, the lower oxidation value may be less than 50%.

Variable oxidation of sulphur is relevant to normal operations and to operations under reduced capacity conditions, i.e. situations in which plant equipment is off-line.

Variable oxidation of sulphur allows changes in oxidation having regard to variations in feed mineralogy and other factors.

The lower % oxidation value in the target % oxidation range may be 50%.

The lower % oxidation value in the target % oxidation range may be 60%.

The lower % oxidation value in the target % oxidation range may be 65%.

An upper % oxidation value in the target % oxidation range may be 95%.

An upper % oxidation value in the target % oxidation range may be 100%.

A preferred target oxidation value in the target % oxidation range for a greenfield plant is mid-way in % oxidation between the lower oxidation value and 100%.

The method does not have to vary feed rate and feed type to the oxidation units, such as autoclave units, Therefore, it is not critical to the invention to know the sulphide concentration in the feed to the oxidation units and to control operation based on the sulfide concentration. This simplifies plant operation.

It can be appreciated from the above that the invention may allow the % oxidation of sulphur to vary with the sulphide concentration in feed to the oxidation units, with the % oxidation moving up and down the recovery-oxidation curve for the ore to fit ore type, sulphur grade and equipment available at the time.

As a consequence, the invention makes it possible to simplify process control in the oxidation units and process control upstream and downstream of the oxidation units.

The method may include oxidising less than 90% of the sulphur in the minerals.

The method may include oxidising less than 85% of the sulphur in the minerals.

The method may include oxidising less than 80% of the sulphur in the minerals.

The method may include oxidising greater than 50% of the sulphur in the minerals.

The method may include oxidising greater than 55% of the sulphur in the minerals.

The method may include oxidising greater than 60% of the sulphur in the minerals.

The temperature and pressure conditions in the oxidation units may be any suitable conditions.

Oxidation step (c) may include oxidizing sulphur in the ore preparation unit output with any suitable oxidant.

By way of example, the oxidant may be nitric acid or an oxygen-containing gas, such as commercial grade oxygen or air.

When the oxidant is an oxygen-containing gas, step (d) may include supplying an oxygen-containing gas to the oxidation units at a constant mass flow rate and allowing variations in the % oxidation with the sulphide concentration in feed material, i.e. ore preparation unit output, typically in the form of slurries, to the oxidation units and the residence time of feed material in the oxidation units. This is a straightforward operating practice.

Step (d) may include supplying an oxygen-containing gas to the oxidation units at a variable mass flow rate and allowing variations in the % oxidation with the flow rate of the oxygen-containing gas, the sulphide concentration in feed material, and the residence time of feed material in the oxidation units. This may occur, for example, when the uptime of an oxygen/air delivery system for an oxidation unit is restricted.

Step (d) may include indirectly controlling oxidation in the oxidation units by controlling the operation of other unit operations so that the extent of oxidation is an outcome of controlling other unit operations.

By way of example, step (d) may include controlling one or more than one unit operation upstream and/or downstream of the oxidation units and, as a consequence, indirectly controlling the % oxidation in the oxidation units.

Step (d) may include controlling the levels of feed material for the oxidation units, in one or more holding tanks or other storage facilities for the oxidation units. The invention extends to any suitable storage facilities upstream of the oxidation units.

Controlling the levels of the feed material in one or more holding tanks or other storage facilities makes it possible to operate the method as a self-correcting system when there are changes to the operation of upstream and downstream plant equipment.

The holding tanks are a convenient control option from a plant operator perspective.

For example, step (d) may include maintaining the feed material in the holding tanks between a lower and an upper level in the tanks.

The upper and lower limits may be any suitable levels in the holding tanks.

The upper and lower limits may be the same or different limits in the holding tanks.

By way of further example, step (d) may include maintaining a set feed material level in the holding tanks.

The set level may be the same or different set levels in the holding tanks.

The set level may be any suitable level in the holding tanks.

Maintaining the feed material level at the set level in the holding tanks means that the flow rate from the holding tanks into the oxidation units matches the feed flow rate into the holding tanks. Therefore, the only variables from the perspective of the amount of oxidation in the oxidation units are the oxygen-containing gas flow rates into the oxidation units and the amount of sulphur in the feed material.

If there is a change to the rate of supplying feed material into the holding tanks, for example as a consequence of a change in production rate of the ore preparation unit, there will be a change in the amount of sulphur in the feed material into the oxidation units. If the feed material flow rate drops and (a) the sulphur concentration in the feed material and (b) the mass flow rate of oxygen into the oxidation units remains the same, the amount of oxidation will drop. From an overall operational perspective, this is not an issue, because it is not critical to the invention to keep the oxidation at the target % oxidation or at conventional complete oxidation. The downstream gold recovery unit operations can be tailored to optimize gold recovery from partially oxidized feed material.

A key advantage of the invention is that the ore preparation unit throughput can be maintained at a maximum throughput for the available ore preparation unit capacity at all times.

Ore preparation unit capacity that is in excess of that able to be processed in the oxidation step (c) can be sent to a sulphide concentration unit e.g. a flotation unit. This option is available for the invention because the invention is less sensitive to feed concentration and at a fixed oxygen addition the % oxidation is merely lowered.

It is noted that it is not a first preference to vary oxygen addition or ore preparation unit throughput or oxidation unit capacity at all to achieve the target % oxidation range, although these are options for the invention.

A preferred option for the invention is to maximize ore preparation unit throughput and oxidant, such as oxygen-containing gas, addition at all times.

The method may include a final gold recovery step of recovery gold from liberated gold in the output of oxidation step (c).

The final recovery step may be any suitable recovery step.

The final recovery step may be cyanide, halides (including chloride), thiosulphate or any means for final gold recovery, noting that oxidation step (c) is essentially a pre-treatment technology for gold recovery by any known method.

The method may include a step of adjusting the distribution of the ore preparation unit output to oxidation units in the event of a loss of operational uptime of any one or more of the oxidation units so that all of the ore preparation unit output is distributed to the operational oxidation units.

The method may include processing at least a part of the ore preparation unit output in a sulphide concentration unit, such as a flotation unit, and producing a concentrate of the ore preparation unit output, referred to herein as the sulphide concentrate output.

The method may include supplying the sulphide concentrate output to the oxidation units, together with or as a replacement for the ore preparation unit output, and oxidizing sulphur in the sulphide concentrate output in the oxidation units.

The method may include a step of adjusting the distribution of the sulphide concentrate output to the oxidation units in the event of a loss of operational uptime of any one or more of the oxidation units so that all of the sulphide concentrate output is distributed to the operational oxidation units.

The method may include a step of adjusting the distribution of the ore preparation unit output and the sulphide concentrate output and the concentrate output to the oxidation units in the event of a loss of operational uptime of any one or more of the oxidation units so that all of the ore preparation unit output and the sulphide concentrate output is distributed to the operational oxidation units.

The recovery-oxidation curve for sulphur in the gold-containing minerals provides useful information for the selection of optimum oxidation conditions in the adjustment step.

As is discussed further below, the oxidation conditions may include operating with the same oxidation conditions, such as oxygen supply rate when the oxidant is an oxygen-containing gas, as the oxidation conditions prior to the loss of operational uptime of an oxidation unit going off-line.

As noted above, it is not a first preference to vary oxygen addition or ore preparation unit throughput or oxidation unit capacity at all to achieve the target % oxidation range, although these are options for the invention.

A preferred option for the invention is to maximize ore preparation unit throughput and oxidant input, such as oxygen-containing gas, addition at all times. The % oxidation varies according to sulphur grade of feed sulphide. It will also vary according to the actual ore preparation unit throughput—if that is in any way limited or oxidant addition if that is in any way limited.

Other factors that are relevant to the selection of optimum oxidation conditions in the adjustment step include, by way of example only, the extent to which the operating conditions can be changed, the likely downtime of the autoclave unit, and the increased operating costs associated with any change to oxidation conditions.

When the ore preparation unit power input (per tonne of ore) and the oxidant addition are maximized, the operating cost in terms of $/h does not significantly change. However, the $/oz produced, or $/t milled will reduce as ore throughput increases.

The adjustment step may include adjusting the distribution of the feed sulphide, output without reducing the ore preparation unit output in the milling unit and, when present, the concentrate output in the flotation unit. From an operational perspective, this is a preferred option.

The adjustment step may include adjusting the distribution of the feed sulphide, output to the sulphide concentration unit e.g. a flotation unit.

The invention provides a processing plant for recovering gold from gold-containing sulphide minerals, such as gold-bearing pyrite and arsenian pyrite minerals, in an ore that has a recovery-oxidation curve in a graph of % recovery of gold versus % oxidation of the minerals that has a slope of less than 1:1 in a higher % oxidation part of the curve:

(a) an ore preparation unit that includes, for example, comminution and size separation units, such as crushing and milling units, for processing a mined ore and producing an ore preparation unit output from a mined ore, and

(b) at least one oxidation unit, such as an autoclave unit, with the oxidation unit being operable for oxidizing sulphur in the ore preparation unit output to be in the higher oxidation part of the curve and less than complete oxidation, typically being operable for oxidizing sulphur in a target range of % oxidation value for sulphur in the ore, and for allowing variable oxidation and producing an oxidation unit output having liberated gold as a consequence of sulphur oxidation.

Typically, the plant includes a plurality of oxidation units in a parallel circuit.

Typically, the plant includes a sulphide concentration unit, such as a sulphide flotation unit, for producing a sulphide concentrate output from at least a part of the ore preparation unit output.

With this arrangement, the oxidation units may be used for oxidizing sulphur in the concentrate output of the flotation unit.

With this arrangement, the plant may include a system for changing the distribution of the ore preparation unit output and the sulphide concentrate output to the oxidation units in the event of any one or more of the oxidation units not being operational during periods of equipment downtime, for example due to equipment failure so that all of the ore preparation unit output and the concentrate output is distributed to the remaining operational oxidation unit(s) in the case of option (a) or across the oxidation units having regard to the processing capacity in the case of option (b), and oxidizing sulphur in the ore preparation unit output and the concentrate output in the oxidation units.

With this arrangement, the plant may include a system for changing the distribution of the ore preparation unit output and the sulphide concentrate output to the oxidation units in the event of a loss of equipment uptime so that all of the ore preparation unit output and the concentrate output is distributed to the operational oxidation unit(s) and oxidizing sulphur in the ore preparation unit output and the sulphide concentrate output in the operational oxidation units.

The plant may further include a metal recovery unit for recovering gold from the oxidation unit output of at least one oxidation unit.

The invention is equally applicable to a greenfield plant and a brownfield plant.

In addition to the above, in more general terms, the invention provides a method of recovering a precious metal from minerals in an ore that has a recovery-oxidation curve in a graph of % recovery of precious metal versus % oxidation of sulphur in the minerals that has a slope of less than 1:1 in a higher % oxidation part of the curve, including:

(a) processing a mined ore in an ore preparation unit that includes, for example, comminution and size separation units, such as crushing and milling units, and producing an ore preparation unit output,

(b) selecting a target range of % oxidation values for sulphur in the ore to be in the higher oxidation part of the curve and less than complete oxidation; and

(c) selecting the operating conditions for a plurality of oxidation units, such as autoclave units, to achieve oxidation in the target range of % oxidation values for sulphur in the preparation unit output in at least one oxidation unit, such as an autoclave unit, and operating the oxidation unit or units in accordance with the operating conditions and oxidizing sulphur in the ore preparation unit output and producing an output having liberated gold as a consequence of sulphur oxidation in the oxidation units; and

(d) allowing variations of the % oxidation in oxidation units, such as autoclave units, during the method.

In addition to the above, in more general terms, the invention provides a processing plant for recovering a precious metal from minerals in an ore that has a recovery-oxidation curve in a graph of % recovery of gold versus % oxidation of the minerals that has a slope of less than 1:1 in a higher % oxidation part of the curve:

(a) an ore preparation unit that includes, for example, comminution and size separation units, such as crushing and milling units, for processing a mined ore and producing an ore preparation unit output from a mined ore, and

(b) at least one oxidation unit, such as an autoclave unit, in a parallel circuit, with each oxidation unit being operable for oxidizing sulphur in the ore preparation unit output to be in the higher oxidation part of the curve and less than complete oxidation, typically being operable for oxidizing sulphur in a target range of % oxidation value for sulphur in the ore, and for allowing variable oxidation and producing an oxidation unit output having liberated gold as a consequence of sulphur oxidation.

### BRIEF DESCRIPTION OF THE DRAWINGS

The invention is described further below with reference to the accompanying drawings, of which:

FIG. 1 is a series of recovery-oxidation curves for several typical gold-containing sulphide minerals in a graph of % recovery of gold from gold-containing sulphide minerals versus the % oxidation of the minerals; and

FIG. 2 is a diagram of a gold processing plant for carrying out one embodiment of a plant and a method for recovering gold from an ore that contains gold-containing sulphide minerals in accordance with the invention; and

FIG. 3 is a diagram of a gold processing plant for carrying out another but not the only other embodiment of a plant and a method for recovering gold from an ore that contains gold-containing sulphide minerals in accordance with the invention.

### DESCRIPTION OF EMBODIMENTS

The following description of embodiments of the invention is in the context of gold as the precious metal being recovered from an ore.

As noted above, the invention takes into account information in recovery-oxidation curves for gold-containing sulphide minerals, such as gold-bearing pyrite and arsenian pyrite minerals, in situations where there is a breakdown of plant equipment or reduced capacity of such equipment for any reason to assist in designing plants and in selecting optimum operating conditions while equipment is off-line. In this context, the invention is relevant to greenfield plants and brownfield plants.

As noted above, the invention also provides an opportunity for increasing capacity in brownfields plants that have been previously designed for 100% oxidation, for example.

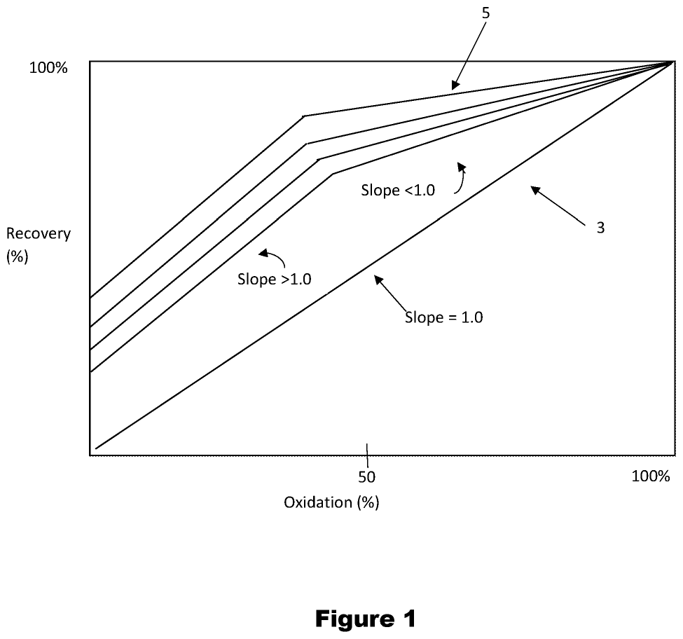

The graph of % recovery of gold from gold-containing sulphide minerals versus the % oxidation of sulphur in the minerals in FIG. 1 shows the recovery-oxidation curves for several typical gold-containing sulphide minerals.

With reference to FIG. 1, the straight line identified by the numeral 3 in FIG. 1, which extends from the origin with a slope of 1:1 is a typical curve for a significant percentage of one group of known gold-containing sulphide minerals in which, for example, there is a uniform dispersion of gold particles in fine pyrite particles. It is clear from the line 3 that changing the amount of oxidation of these minerals has a significant effect on recovery. For example, decreasing the oxidation from 80% to 70% will result in a proportional decrease in the gold production rate.

With further reference to FIG. 1, the curves described by the lines identified by the numeral 5 in FIG. 1 are typical curves for a significant percentage of another group of known gold-containing sulphide minerals.

The curves 5 are in a section of the graph of FIG. 1 that is above the line 3 that has the 1:1 slope.

The curves 5 have (a) a slope of greater than or equal to 1:1 in a lower part of the curves that have lower oxidation values and (b) a slope of less than 1:1 in a higher part of the curves that have higher oxidation values 5. The transition between the lower and higher parts of the curves 5 is typically approximately 50% oxidation for the curves 5 shown in FIG. 1. However, this transition will vary depending on factors such as the ore type. For example, the applicant is aware of ores that have transitions around 30% and lower than 30%.

It can be appreciated from the curves 5 that changing the % oxidation of these minerals in the parts of the curves 5 that have a slope of less than 1:1, i.e. above approximately 45% oxidation in FIG. 1, has a minimal effect on recovery because the curves are nearly flat within this range. For example, decreasing the oxidation from 80% to 70% will result in a minimal decrease in the gold recovery while allowing significantly higher mass flowrate of ore. This slope of the curves provides flexibility with respect to plant operation. The flexibility is relevant when all of the plant equipment is operating properly. The flexibility is also relevant when there is a loss of equipment up-time.

In relation to a designing a plant for processing an ore in a greenfield plant or operating a brownfield plant, the method of the invention includes:

(a) selecting a target range of % oxidation values for sulphur in an ore for a plurality of oxidation units, such as autoclave units, to be in the higher part of the recovery-oxidation curve 5 for the ore that has a slope of less than 1:1 as shown in FIG. 1 and less than complete oxidation; and

(b) selecting the operating conditions for the plurality of oxidation units, such as autoclave units, to achieve oxidation in the target % oxidation range for sulphur in the preparation unit output (such as produced via crushing and milling units and supplied to the oxidation units as a slurry) and operating the oxidation units in accordance with the operating conditions and oxidizing sulphur in the preparation unit output and producing an output having liberated gold as a consequence of sulphur oxidation in the oxidation units; and

(c) allowing variations of the % oxidation in the autoclave units during the method.

The invention is an alternative to the conventional operating practice of complete oxidation.

Typically, when designing a greenfield plant, a preferred target oxidation value is mid-way between a lower limit (where the slope of the recovery-oxidation curve 5 increases to >1 and 100% oxidation or to a range around the preferred target oxidation value—at say 70% for the curve 5 shown in the Figure.

The invention makes it possible to allow the % oxidation to vary from the target % oxidation value having regard to factors such as mineralogy of the ore and concentrates of the ore supplied to the oxidation units and equipment availability, without having a significant impact on the total amount of gold produced by the plant.

In other words, it is not essential to the invention to adjust oxidation inputs to maintain the target % oxidation value.

As a consequence, the operation of the oxidation units, such as the autoclave units, is no longer dependent on the amount of sulphur in a feed slurry to the oxidation units to the extent that was the case with the complete sulphur oxidation practice. This is relevant to greenfield plants and brownfield plants.

In addition, as a consequence, by no longer requiring complete oxidation and allowing variations in % oxidation, the invention makes it possible to operate with significantly higher mass flowrates of ores and concentrates in brownfield plants and to significantly increase gold production.

As is discussed above, as a consequence, the design of the oxidation units can be more straightforward and have flow-on advantages in terms of capital and operating costs in the plant.

For example, as is discussed above, the lower capital costs can be realized by avoiding over-design of oxidation units and other plant equipment.

For example, as is discussed above, the lower operating costs can be realized by lower oxygen requirements for the plant and an opportunity to continue operation in situations where equipment goes off-line.

In addition, as a consequence, the invention provides flexibility in terms of plant operation and can operate effectively in situations where there is a loss of equipment uptime, for example which results in preparation unit capacity exceeding oxidation unit capacity and vice versa.

### Examples—Operational Flexibility of the Invention

The two examples in this section are two of many examples of the operational flexibility of the invention.

The two examples apply to oxidation units in the form of autoclave units that always burn the same mass of sulphur. This is not an essential feature of the invention. However, it is a standard operating practice for conventional autoclave units.

The two examples also apply to plants that include flotation units for processing a part of an ore preparation unit output, i.e. output from crushing and milling units, of the plants.

In a 1^{st} example, an autoclave unit capacity drops, e.g. there is one less autoclave unit. In this example, in accordance with an embodiment of the invention,
the feed slurry to that autoclave unit is diverted to the remaining autoclave units,
there is less capacity to burn sulphur because there are fewer autoclave units,
the ore preparation unit output remains the same,
a higher % of the ore preparation unit output is diverted into flotation so that there is higher sulphur in feed to the autoclave units, with a result that in overall terms there is a lower % of the sulphur in the feed that is burnt and a resultant lower % oxidation and therefore there is a move to the left of the curve 5,
there is a lower gold recovery, although given the slope of the curve 5, this loss is not substantial.

In a 2^{nd} example, the ore preparation unit (such as crushing and milling units) capacity drops. In this example, in accordance with an embodiment of the invention,
a smaller % of the preparation unit output is diverted into flotation than was previously the case to maintain throughput to the autoclave units,
this means that a higher % of sulphur in the feed is burnt and a resultant higher % oxidation for the same autoclave unit throughput and autoclave operating conditions and therefore, there is a move to the right of the curve.

### Example—Benefits of the Invention

The benefits of the invention in terms of gold production are described further below by way of example with reference to the following Table which provides information on two operating modes A and B for a plant, with Mode A being conventional high % oxidation operation (95%, i.e. complete oxidation) and Mode B being in an accordance with an embodiment of the invention.

TABLE
Gold Production Benefits

| Slope Au % Recovery | | | | | | |
|---|---|---|---|---|---|---|
| vs % Oxidation Curve | Units | 1.00 | 0.10 | 0.15 | 1.20 | 1.50 |
| Conventional operation | | | | | | |
| (Mode A) | | | | | | |
| Initial Oxidation | % | 95 | 95 | 95 | 95 | 95 |
| (Mode A) | | | | | | |
| Initial Recovery | % | 95 | 95 | 95 | 95 | 95 |
| Intercept of Line | % | 0 | 85.5 | 80.75 | −19 | −47.5 |
| Calculated | | | | | | |
| Initial Throughput | dtph | 300 | 300 | 300 | 300 | 300 |
| to Oxidation Process | | | | | | |
| Feed % Sulphur | % | 6 | 6 | 6 | 6 | 6 |
| to Oxidation Process | | | | | | |
| Gold Feed Grade | gpt | 3 | 3 | 3 | 3 | 3 |
| Gold:Sulphur Ratio | Au gpt/% S | 0.5 | 0.5 | 0.5 | 0.5 | 0.5 |
| Sulphur Oxidised | dtph | 17.1 | 17.1 | 17.1 | 17.1 | 17.1 |
| Initial Gold Recovered | ounces/h | 27.5 | 27.5 | 27.5 | 27.5 | 27.5 |
| The invention | | | | | | |
| (Mode B) | | | | | | |
| New Oxidation | % | 60 | 60 | 60 | 60 | 60 |
| New Recovery | % | 60.0 | 91.5 | 89.8 | 53.0 | 42.5 |
| Throughput | dtph | 300 | 300 | 300 | 300 | 300 |
| Gold:Sulphur Ratio | ratio | 0.5 | 0.5 | 0.5 | 0.5 | 0.5 |
| Sulphur Feed Grade | % s | 9.5 | 9.5 | 9.5 | 9.5 | 9.5 |
| Gold Feed Grade | gpt | 4.75 | 4.75 | 4.75 | 4.75 | 4.75 |
| New Gold Recovered | ounces/h | 27.5 | 41.9 | 41.1 | 24.3 | 19.5 |

The Table summarizes operating conditions for five ores that have different % recovery versus % oxidation curves, with the following slopes of the curves: 0.1:1, and 0.15:1 (in accordance with the invention, i.e. examples of curves 5 shown in FIG. 1) and 1:1, 1.2:1 and 1.5:1 (outside invention).

With reference to FIG. 1, the % recovery versus % oxidation curves 5 can be described by the following formula:

y=mx+c

where m=slope, c=intercept, y=% recovery, and x=% oxidation.

Mode A

In the conventional operating conditions of Mode A in the Table, each autoclave unit 13 is operating with:
a throughput of 300 tph.
a recovery for each ore at 95% (because the 95% oxidation means that each ore is at the far right of the % recovery v % oxidation for each curve).
6% sulphur in the feed material.
an average gold grade of 3 gpt of feed material, with an Au:S ratio of 3/6=0.5.

Under these conventional operating conditions, the plant recovers 300 (tph)×3 (gpt)×0.95 (% oxidation)÷31.1035 (g/oz)=27.5 ounces of gold per hour—see the Table. Each autoclave unit oxidises 300 (tph)×0.06 (S grade)×0.95 (% oxidation)=17.1 tph S burnt in the autoclave unit.

Mode B

In the new operating conditions of Mode B in the Table, a 60% oxidation is chosen for the purpose of illustration:
the plant operates at the same Au:S ratio of 3/6=0.5 as Mode A.
the plant operates at the same throughput of 300 tph.

Under these conditions and bearing in mind that each autoclave unit will burn the same amount of sulphur as in Mode A, i.e. 17.1 tph, the grade of sulphur fed to the autoclave units will be higher than in Mode A—otherwise it would not be possible to burn 17.1 tph sulphur operating at 60% oxidation. Specifically, the new grade of sulphur in each autoclave unit can be calculated from the Table to be: 300 (tph)×Y (S grade)×60% (% oxidation)=17.1 tph sulphur. Therefore, the sulphur grade Y in the autoclave units=17.1 tph S÷(300 (tph)×60% (% oxidation))=9.5%.

Applying these oxidation conditions to the % recovery v % oxidation of sulphur for the selected curve slopes in the Table results in quite different % recoveries—due to the slopes of the curves for the ores. These different % recoveries translate to a wide range of amounts of gold recovered—ranging from 19.5 ounces/hr to 41.9 ounces/hr—depending on the curve slope. For example, at 60% oxidation for say a slope of 0.1:1, the recovery is now 91.5%. Therefore, 300 (tph)×9.5 (S grade)×0.5×0.915 (% oxidation)÷31.1035 (g/oz)=41.9 ounces of gold per hour—see the Table.]

It can be appreciated from the Table and the above analysis that in Mode B the ores with curves having slopes of 0.1:1 and 0.15:1 in accordance with the invention had considerably higher gold recoveries than the other ores with curves with higher slopes for the same plant throughput, demonstrating the flexibility of the invention to accommodate changes in operating conditions when processing ores with curves having slopes in accordance with the invention.

There are other possible modes in addition to Mode B.

One other mode increases throughput of the oxidation units. This leads to lower % oxidation but higher feed mass of sulphur input and higher gold production oz/h. Specifically, increasing mass throughput means that a lower % of sulphur in the feed is burnt (i.e. a lower % oxidation and a move to the left in the curves 5) given that the amount of sulphur burnt is fixed in the autoclave units. However, the relatively flat slope of the curves 5 means there is no significant loss of recovery and, moreover, the higher mass throughput means that there will be increased gold output from the plant depending on the increase in the mass throughput.

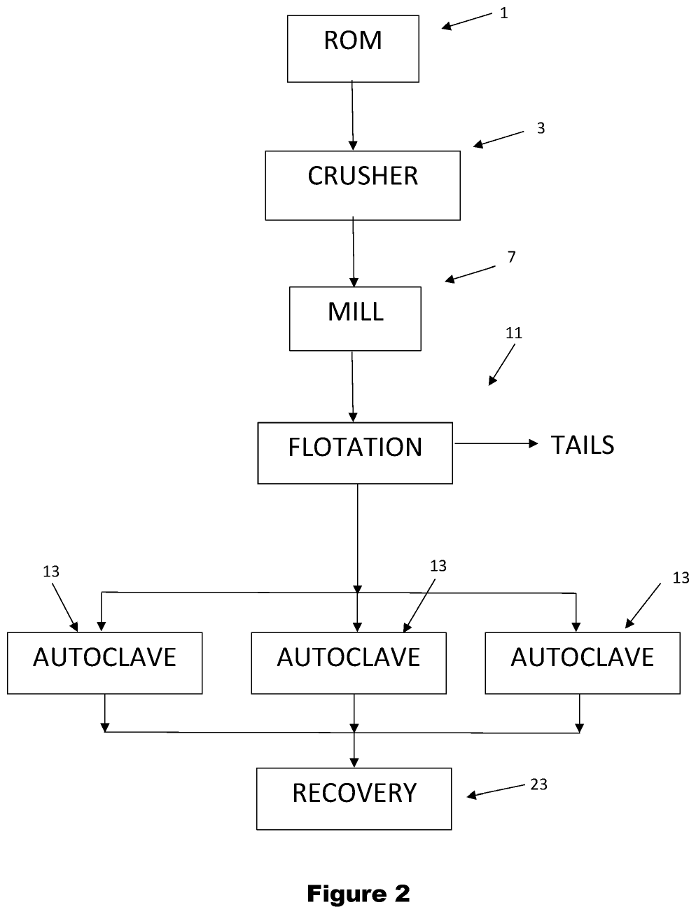

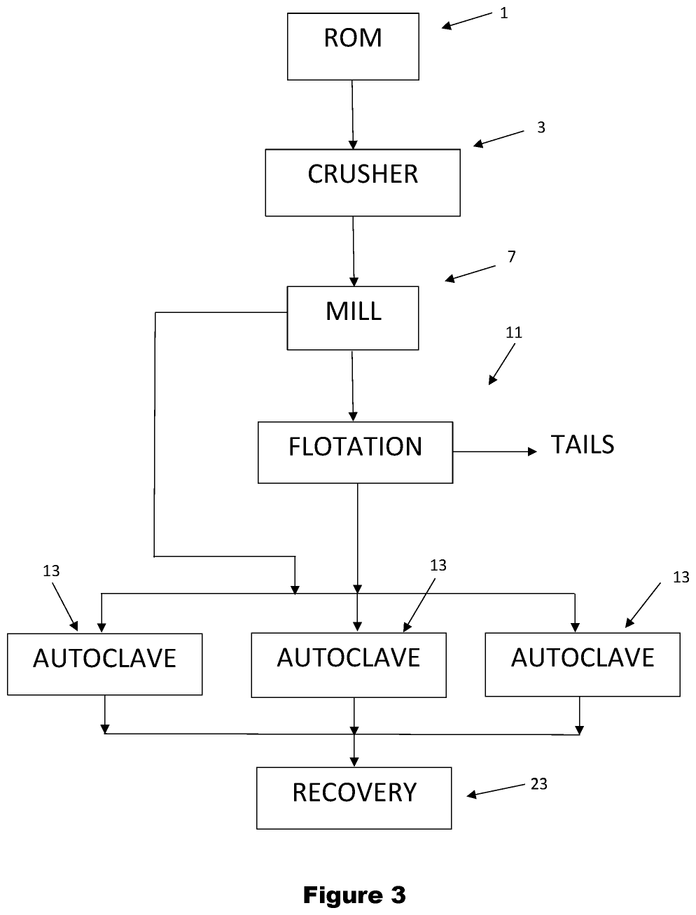

The invention is explained further with reference to the embodiments shown in FIGS. 2 and 3.

### Embodiment—FIG. 2

With reference to the flow sheet of FIG. 2, mined gold-bearing ore (ROM) 1 from a mine or a mine stockpile is subjected to ore preparation in an ore preparation unit, as follows.
The ore is subjected to primary crushing in a crusher unit 3, which may be a plurality of separate crusher units 3, for example gyratory crushers and jaw crushers and other types of crushing units.
The crushed ore produced in the crusher unit 3 may be stored in a coarse ore stock pile (not shown).
Coarse ore from the crusher unit 3 and/or the coarse ore stock pile is supplied to a milling unit 7, typically including SAG mills, but may be any other suitable mills, and produces a mill output. The mill output is in the form of slurries (typically having 40-60 wt. % solids) having any suitable particle size distribution.

The entire mill output from the milling unit 7 is supplied as a slurry via a transfer line to a flotation unit 11. The mill output is the ore preparation unit output.

It is noted that other embodiments of the invention do not include a flotation unit 11. It is also noted that other embodiments of the invention, such as described in relation to FIG. 3, include a flotation unit 11 and split the mill output, with part of the output being transferred to the flotation unit 11 and another part of the mill output being transferred directly to the autoclave units 13.

The flotation unit 11 produces a concentrate slurry. The concentrate slurry is transferred via a transfer line to a plurality (could be 3 or any other suitable number) of oxidation units in the form of autoclave units 13. It is noted that the invention is not confined to the use of autoclave units and extends to any suitable oxidation units for oxidizing sulphur in the concentrate slurry.

The flotation unit 11 also produces a tails slurry. This is transferred via a transfer line for downstream processing (not shown in the Figure).

The flotation unit 11 may be any suitable unit.

The autoclave units 13 oxidize sulphur in the concentrate slurry and produce an autoclave output.

The autoclave output from the autoclave units 13 is transferred via a transfer line to a metal recovery unit 23 for recovering gold. The metal recovery unit 23 may be any suitable unit. One example of a suitable gold-recovery operation is a carbon-in-leach (CIL) process.

The autoclave units 13 may be any suitable units operating at suitable elevated pressure and temperature conditions, with an oxygen plant (not shown) supplying an oxygen-containing gas, typically pure oxygen, to the autoclaves of the autoclave units 13 and a holding tank (not shown) that stores the concentrate slurry to be supplied to the autoclaves of the autoclave units 13.

By way of example, typical operating conditions in the autoclave units are as follows:
Elevated temperature—at least 2.00° C.
Elevated pressure—at least 2500 kPa
95-100% O₂
Exothermic

In the autoclave units 13, the concentrate slurry and oxygen react under elevated temperature and pressure conditions, with the sulphur being oxidized to facilitate liberation of gold.

As is described further below, the autoclave units 13 selectively oxidize sulphur to a target range of % oxidation values for the ore that is in the higher part of the recovery-oxidation curve 5 in FIG. 1, i.e. with a slope of <1:1, for the ore in the autoclave units 13, and less that complete, i.e. 100% oxidation.

The oxidation parameters, such as oxygen flow rate and residence time, may be a fixed or variable in each autoclave unit 13, and there may be differences in % oxidation values and variations of these values in different autoclave units 13 depending on operational factors.

It is noted that, typically, the oxygen flow rate and residence time in the autoclave units 13 are fixed and the % oxidation in the autoclave units 13 is allowed to vary, if necessary.

One feature of the plant shown in FIG. 2 is being able to continue to operate the plant effectively in the event that one or more than one of the autoclave units 13 is (a) not operational during periods of equipment downtime, for example due to equipment failure or other reasons, and is taken off-line or (b) is operational at reduced throughput for any reason. It is more common that there be reduced throughput rather than equipment being off-line, but the impact is the same.

In the event of an autoclave unit 13 going off-line, the entire concentrate slurry from the flotation unit 11 is distributed to the remaining operational autoclave units 13 and there is no change to the operation of the milling unit 7 and the flotation unit 11.

Specifically, if one of the autoclave units 13 is taken off-line:
the crusher unit 3 and the milling unit 7 continue to operate at maximum capacity and transfer the entire mill output as the ore preparation unit output to the flotation unit 11; and
the flotation unit 11 continues to transfer concentrate slurry to the remaining operational autoclave units 13, with each remaining autoclave unit 13 processing a higher throughput of concentrate slurry.

The oxidation conditions for these remaining operational autoclave units 13 change automatically to accommodate the higher throughputs of concentrate slurry, as is described further below.

The comparatively flat slope of <1:1 of the higher part of the recovery-oxidation curve 5 for the ore means that the gold recovery does not change greatly as the % oxidation moves up and down the curve 5 within the % oxidation in the higher part of the curve 5.

As a consequence, it is not as important as it may otherwise have been with a steeper slope to change the operating conditions, such as mass throughput, in the remaining autoclave units 13.

The options for oxidation conditions include (a) operating with the same target range of % oxidation values in the remaining operational autoclave units 13 as that prior to the autoclave unit 13 going off-line or (b) operating with a different target range of % oxidation values in the remaining operational autoclave units 13 to that prior to the autoclave unit 13 going off-line.

Option (a) typically requires changes to one or both of the oxygen flow rate and residence time in the autoclave units. Option (b) is a preferred option because it is not necessary to change the oxygen flow rate and residence time in the autoclave units with this option.

The above-described sharing of the concentrate slurry from the flotation unit 11 across the remaining operational autoclave units 13 makes it possible to process all of the concentrate output, with no changes to the operation of the milling unit 7 and the flotation unit 13.

Another feature of the plant shown in FIG. 2, which is connected to option (b), is that the % oxidation in the autoclave units 13 can vary as a function of factors outside the autoclaves such as ore type, S grade, and equipment availability while remaining within the higher part of the recovery-oxidation curve 5 for the ore in FIG. 1 without a significant impact on gold recovery and is allowed to do so in the standard operation of the plant.

For example, the method may include operating with variable % oxidation in the autoclave units 13.

This means that the autoclave units 13 are not the key unit operation in terms of controlling the operation on the plant and there is greater flexibility to optimize and accommodate variations in the upstream and downstream unit operations of the plant.

The method makes it possible to maximize feed rate to the autoclave units 13 at all times irrespective of equipment availability (upstream and downstream of the autoclave units 13) and ore type variability and without being dependent on a target sulphur % oxidation in each of the autoclave units 13.

In the embodiment of the invention shown in FIG. 2, a holding tank (not shown) of each autoclave unit 13 is used as a key indicator of plant operation and process control.

The holding tanks are tanks that hold volumes of concentrate slurry ready for supply as fed material to the autoclave units 13.

The holding tanks are a convenient process control option from a plant operator perspective.

For example, the method may include maintaining the concentrate slurry in the holding tanks between a lower and an upper level in the tanks.

The upper and lower limits may be any suitable levels in the holding tanks.

The upper and lower limits may be the same or different limits in the holding tanks.

Another process control strategy option comprises controlling the slurry levels in the holding tanks of the autoclave units 13 at set levels in the tank. The set levels may be any suitable levels. The set levels may be the same or different levels in the holding tanks.

A constant tank level in the holding tanks means that the volumetric outputs from the holding tanks to the autoclave units 13 matches the combined volumetric output of the flotation unit 11 to the autoclave units 13. Therefore, with the oxygen plants of the autoclave units 13 operating at a fixed volumetric flow rate to the autoclave units 13, the amount of sulphur oxidation will be a function only of the sulphur concentration from the flotation units 11 and may vary.

It is not essential that the % oxidation in the autoclave units 13 be constant amounts. The downstream gold recovery operating conditions can vary as required to accommodate any given % oxidation in the autoclave units 13.

A preferred plant operation includes the ore preparation unit, i.e. the crusher unit 3 and the milling unit 7, operating at a maximum, constant capacity and variations in crusher/mill operation being minimized to the extent possible. This is beneficial from an operational perspective for the crusher unit 3 and the milling unit 7. In addition, the applicant has found that de-coupling crusher/mill operation from autoclave operation, which is possible with the invention, increases substantially the throughput of ore through the plant and the amount of gold recovered in any given time period.

By way of further example, controlling plant operation having regard to the slurry level in the holding tanks of the autoclave units 13 provides control flexibility.

### Embodiment—FIG. 3

FIG. 3 is a diagram of another, although not the only other possible, embodiment of the gold processing plant for carrying out another embodiment of a plant and a method for recovering gold from an ore that contains gold-containing sulphide minerals in accordance with the invention.

The embodiments shown in FIGS. 2 and 3 are very similar, and the same reference numerals are used to describe the same features in the Figures.

One main difference is that the ore preparation unit output from the crusher unit 3 and the milling unit 7 is supplied via a transfer line 9 to a flotation unit 11 and to the three autoclave units 13. The split between the amount of ore preparation unit output transferred to the flotation unit 11 and the amount of ore preparation unit output transferred to the autoclave units 13 may vary depending on operational requirements, including the sulphur and other characteristics of feed ore to the units 11, 13.

As a consequence, the autoclave units 13 oxidize sulphur in the ore preparation unit output from the crusher unit 3 and the milling unit 7 and sulphur in the concentrate slurry from the flotation unit 11 and produces an autoclave output.

In the autoclave units 13, the ore preparation unit output and the concentrate slurry and oxygen react under elevated temperature and pressure conditions, with the sulphur being oxidized. As described further below, the autoclave units 13 selectively oxidize sulphur to predetermined amounts in the autoclave units 13, which may be a fixed or variable amount in each autoclave with differences in amounts and variations of amounts in different autoclaves depending on operational factors.

A key feature of the plant shown in FIG. 3 is flexibility to transfer at least a part of the ore preparation unit output produced in the crusher unit 3 and the milling unit 7 to the flotation unit 11 and to the autoclave units 13.

The feature provides further operational flexibility to the embodiment described in relation to FIG. 2 in the event that the flotation unit 11 and/or one or more than one of the autoclave units 13 is not operational during periods of equipment downtime, for example due to equipment failure or other reasons.

By way of example, in the event that one of the autoclave units 13 goes off-line, the option of transferring at least a part of the ore preparation unit output to the remaining operational autoclave units 13 adds flexibility to the FIG. 2 embodiment.

In addition, in the event that the flotation unit 11 goes off-line, the entire ore preparation unit output can be transferred to the autoclave units 13 and be processed in the autoclave units 13, with appropriate adjustments to oxidation conditions in the autoclave units 13.

In the embodiment of the invention shown in FIG. 3, as is the case with the FIG. 2 embodiment, the holding tank (not shown) of each autoclave unit 13 is used as a key indicator of plant operation and process control.

If, for some reason, oxidation throughput in an autoclave unit 13 drops, then the storage tank level increases and, since ore preparation throughput is always maximized, additional ore is sent to flotation to maintain the level in the holding tank. The % sulphur in the ore increases. Almost the same mass flow of sulphur is sent to the autoclave units 13 and, therefore, the overall % oxidation is reduced and the % oxidation moves to the left on the curve 5 for the ore in FIG. 1.

The control system ensures that the operating conditions do not go below the lower limit or above an upper limit of the flat slope section on the curve 5 or move outside the limits for other operating parameters that are important for keeping equipment in a preferred state—e.g. not too low in oxidation reduction potential such that titanium in an autoclave is compromised.

For example, the method may include maintaining the ore preparation unit output and the concentrate slurry in the holding tanks between a lower and an upper level in the tanks.

Another process control strategy option comprises controlling the slurry levels in the holding tanks of the autoclave units 13 at set levels in the tank. The set levels may be any suitable levels. The set levels may be the same or different levels in the holding tanks.

A constant tank level in the holding tanks means that the volumetric outputs from the holding tanks to the autoclave units 13 matches the combined volumetric outputs of the milling unit 7 and the flotation unit 11 to the autoclave units 13. Therefore, with the oxygen plants of the autoclave units 13 operating at a fixed volumetric flow rate to the autoclave units 13, the amount of sulphur oxidation will be a function only of the sulphur concentration in the combined feed slurries from the milling units 7 and the flotation units 11.

In practice, it is likely to be preferred to allow the storage tank level to vary between two levels. At a lower level, flotation of ore would be stopped and ore preparation unit output for the flotation tanks would be send “direct” to the autoclave units 13. At an upper level, more mill output would be sent to flotation.

It is not essential that the % oxidation in the autoclave units 13 be constant amounts. The downstream gold recovery operating conditions can vary as required to accommodate any given % oxidation in the autoclave units 13.

A preferred plant operation includes the crushing unit 3 and the milling unit 7 operating at a maximum, constant capacity and variations in crusher/mill operation being minimized to the extent possible. This is beneficial from an operational perspective for the crusher unit 3 and the milling unit 7. In addition, the applicant has found that de-coupling ore preparation unit operation from autoclave operation, which is possible with the invention, increases substantially the throughput of ore through the plant and the amount of gold recovered in any given time period.

By way of further example, controlling plant operation having regard to the slurry level in the holding tanks of the autoclave units 13 provides control flexibility, and there may be situations where it is preferable to change the split of ore preparation unit output that is diverted directly to the autoclave units 13 and to the flotation tank unit 7. For example, where the ore preparation unit output changes, for example decreases, due to crusher/mill operation issues, it may be possible to compensate for this in part and for a time, via increased output from the flotation unit 11.

The slurry level in the holding tanks of the autoclave units 13 may be maintained at the set levels by adjusting the discharge flow rate from the holding tanks to the autoclave units 13 to match the input flow rates to the holding tanks and vice versa.

As noted above, in practice, it is likely to be preferred to allow the storage tank level to vary between two levels. Oxidation step flowrate is maximised at all times including oxidant addition. If the level increases, float more. If the level decreases, float less. At a lower level, flotation of ore would be stopped, and ore preparation unit output for the flotation unit 11 would be send “direct” to the autoclave units 13. At an upper level, more ore preparation unit output would be sent to flotation.

If there is a change to the rate of supplying feed slurry to the holding tanks, for example as a consequence of a change in output of the crusher unit 3 and the milling unit 7 and/or the flotation unit 11, and the discharge flow rate from the holding tanks is adjusted to match the changes, the levels in the holding tanks will not change. In terms of autoclave operation, there will be changes to the flow rates from the holding tanks into the autoclaves of the autoclave units 13. If the flow rates drop and (a) the sulphur concentration in the slurry, (b) the residence time of the slurry in the autoclave units 13, and (c) the mass flow rate of oxygen into the autoclave units 13 remains the same, the amount of oxidation will drop. As explained above, this is not an issue with the invention, because it is not critical to the invention to operate with complete, i.e. 100%, oxidation, when operating with ores having the curves 3 in FIG. 1.

In a situation where there is a period of variability of the ore preparation unit output, and the discharge flow rate from the holding tanks is adjusted to match the varying flow rates to the holding tanks, the level in the holding tanks will not change. If (a) the sulphur concentration in the slurry, (b) the residence time of the slurry in the autoclave units 13, and (c) the mass flow rate of oxygen into the autoclave units 13 remains the same, the % oxidation will vary with the varying flow rate. As described above, this is not an issue with the invention, because it is not critical to the invention to operate with complete, i.e. 100%, oxidation, when operating with ores having the curves 3 in FIG. 1.

In this context, as noted above, the applicant has found that de-coupling mill operation from autoclave operation increases substantially the throughput of feed through the plant and the amount of gold recovered in any given time period.

Many modifications may be made to the invention described above without departing from the spirit and scope of the invention.

By way of example, whist the embodiments of the invention are described in relation to recovery of gold from gold-containing minerals, typically pyrite or arsenian pyrite, in ores, the present invention is not so limited and extends generally to recovering precious metals from ores.

By way of example, whilst the embodiments of the invention are described in relation to controlling plant operation having regard to the slurry level in the holding tanks of the autoclave units 13, the present invention is not so limited and extends to other control options, such as producing a filter cake.

1. A method of recovering gold in a gold recovery plant from gold-containing sulphide minerals in an ore that has a recovery-oxidation curve in a graph of % recovery of gold versus % oxidation of the minerals that has a slope of less than 1:1 in a higher % oxidation part of the curve, including:
(a) processing a mined ore in an ore preparation unit and producing an ore preparation unit output;
(b) selecting a target range of % oxidation values for sulphur in the ore of the ore preparation unit output to be in a higher oxidation part of the curve and less than complete oxidation and selecting operating conditions for (a) that include a plurality of oxidation unit to achieve oxidation in the target range of % oxidation values for sulphur in the preparation unit output in the oxidation unit;
(c) operating the oxidation unit in accordance with the operating conditions and oxidizing sulphur in the ore preparation unit output and producing an output of the oxidation unit having liberated gold as a consequence of sulphur oxidation in the oxidation unit; and
(d) controlling operation of the plant by allowing variations of the % oxidation of sulphur in the oxidation unit within the target range of % oxidation values for sulphur during the method in response to changes in plant operating conditions.

2. The method of claim 1, wherein the gold-containing sulphide minerals include pyrite or arsenian pyrite.

3. The method of claim 1, wherein (a) includes operating the ore preparation unit at a maximum capacity.

4. The method of claim 1, wherein (d) includes allowing variations in the % oxidation in response to ore type, sulphur grade, and equipment availability.

5. The method of claim 1, wherein (d) includes supplying an oxygen-containing gas to the oxidation unit at a constant mass flow rate and allowing variations in the % oxidation of sulphur in the oxidation unit with the sulphide concentration in a feed material to the oxidation unit and the residence time of the feed material in the oxidation unit.

6. The method defined in of claim 1, wherein (d) includes supplying an oxygen-containing gas to the oxidation unit at a variable mass flow rate and allowing variations in the % oxidation of sulphur with the flow rate of the oxygen-containing gas, the sulphide concentration in a feed material to the oxidation unit, and the residence time of the feed material in the oxidation unit.

7. The method of claim 1, wherein (d) includes indirectly controlling the % oxidation of sulphur in the oxidation unit by controlling the operation of other unit operations so that oxidation is an outcome of controlling other unit operations.

8. The method of claim 7, wherein (d) includes controlling the levels of feed material, typically feed material slurry, for oxidation units in a pre-oxidation holding tank or other storage facilities of the oxidation unit.

9. The method of claim 8, including maintaining the feed material in the holding tank between a lower level and an upper level in the tank.

10. The method of claim 8, including maintaining a set feed material level in the holding tank.

11. The method of claim 1, wherein (d) includes, in a situation where there is a plurality of oxidation units, adjusting the distribution of the ore preparation unit output to the oxidation units in the event of a loss of operational uptime of any one or more of the oxidation units so that all of the ore preparation unit output is distributed to the operational oxidation units.

12. The method of claim 1, including floating at least a part of the ore preparation unit output in a flotation unit and producing a sulphide concentrate output and oxidizing sulphur in the concentrate output in the oxidation units.

13. The method of claim 12, wherein (d) includes, in a situation where there is a plurality of oxidation units, adjusting the distribution of the ore preparation unit output and the sulphide concentrate output and the concentrate output to the oxidation units in the event of a loss of operational uptime of any one or more of the oxidation units so that all of the ore preparation unit output and the sulphide concentrate output is distributed to the operational oxidation units.

14. A processing plant for recovering gold from gold-containing sulphide minerals in an ore that has a recovery-oxidation curve in a graph of % recovery of gold versus % oxidation of the minerals that has a slope of less than 1:1 in a higher % oxidation part of the curve:
(a) an ore preparation unit that includes, for example, comminution and size separation units, such as crushing and milling units, for processing a mined ore and producing an ore preparation unit output from a mined ore, and
(b) a plurality of separate oxidation units, such as autoclave units, in a parallel circuit, with each oxidation unit being operable for oxidizing sulphur in the ore preparation unit output at a target range of % oxidation value for sulphur in the ore to be in the higher oxidation part of the curve and less than complete oxidation,
wherein operation of the plant is controlled by allowing variable oxidation of sulphur in the oxidation units within the target range of % oxidation values for sulphur in response to changes in plant operating conditions and producing an oxidation unit output having liberated gold as a consequence of sulphur oxidation.

15. (canceled)

16. The processing plant of claim 14, including a system for changing the distribution of the ore preparation unit output and the sulphide concentrate output to the oxidation units in the event of a loss of equipment uptime so that all of the ore preparation unit output and the concentrate output is distributed to the operational oxidation unit(s) and oxidizing sulphur in the ore preparation unit output and the sulphide concentrate output in the operational oxidation units.

17-20. (canceled)

21. (canceled)

22. The method of claim 1, wherein (a) includes processing the mined ore in a plurality of oxidation units and producing the ore preparation unit output.

23. The method of claim 22, wherein (b) includes selecting operating conditions for the oxidation units to achieve oxidation in the target range of % oxidation values for sulphur in the preparation unit output in at least one oxidation unit.

24. The method of claim 22, wherein a lower % oxidation value in the target % oxidation range is 50%.

25. The method of claim 22, wherein an upper % oxidation value in the target % oxidation range is 95%.

26. The method of claim 22, wherein (c) includes oxidising greater than 50% and less than 90% of the sulphur in the minerals.
